(19) United States
(12) Patent Application Publication
(10) Pub. No.: US 2026/0228908 A1
(43) Pub. Date: Aug. 6, 2026

(54) OBJECT DETECTION DEVICE, ROBOT SYSTEM, AND OBJECT DETECTION METHOD

(71) Applicant: KAWASAKI JUKOGYO KABUSHIKI KAISHA, Kobe-shi, Hyogo (JP)

(72) Inventors: Kippei MATSUDA, Kobe-shi (JP); Koki YAMANE, Kobe-shi (JP); Ryota IMOTO, Kobe-shi (JP); Tianfen XU, Kobe-shi (JP)

(73) Assignee: KAWASAKI JUKOGYO KABUSHIKI KAISHA, Kobe-shi, Hyogo (JP)

(21) Appl. No.: 19/143,602

(22) PCT Filed: Dec. 26, 2023
(86) PCT No.: PCT/JP2023/046793

§ 371 Date: Jun. 26, 2025

(30) Foreign Application Priority Data
Dec. 28, 2022 (JP) 2022-211357

(51) Int. Cl. G06T 7/70; B25J 9/16; B25J 19/02

(52) U.S. Cl. CPC G06T 7/70; B25J 9/161; B25J 9/163; B25J 9/1664; B25J 9/1697; B25J 19/023; G06T 2207/20081; G06T 2207/20084

(57) ABSTRACT

An object detector 3 includes: a preliminary detector 34 that detects a surface of a polygon of a limited type from a two-dimensional image 44 including an object, using an object detection model 42; and a specifier 35 that specifies position information concerning a three-dimensional position of the surface detected by the preliminary detector 34, based on three-dimensional information 45 corresponding to the two-dimensional image 44.

### FIELD

The technique disclosed here relates to an object detection device, a robot system, and an object detection method.

### BACKGROUND

A device that detects an object is known to date. A device disclosed in Patent Document 1, for example, detects an object by detecting a contour from an image including the object.

### CITATION LIST

### Patent Document

Patent Document 1: Japanese Patent Application Publication No. 2022-18716

### SUMMARY

A machine learning model is often used for detecting an object from an image. By enhancing accuracy of the machine learning model, accuracy of object detection is enhanced. However, if the accuracy of the machine learning model is to be simply enhanced, an annotation load for machine learning increases. Therefore, there is still room for improvement in enhancing the accuracy of object detection.

It is therefore an object of the technique disclosed here to enhance accuracy of object detection.

An object detector according to the present disclosure includes: a preliminary detector that detects a surface of a polygon of a limited type from a two-dimensional image including an object, using a learned model by machine learning; and a specifier that specifies position information concerning a three-dimensional position of the surface detected by the preliminary detector, based on three-dimensional information corresponding to the two-dimensional image.

A robot system according to the present disclosure includes: a robot; an object detector that detects an object; and a robot controller that controls the robot, wherein the object detector includes a preliminary detector that detects a surface of a polygon of a limited type from a two-dimensional image including an object, using a learned model by machine learning, a specifier that specifies position information concerning a three-dimensional position of the surface detected by the preliminary detector, based on three-dimensional information corresponding to the two-dimensional image, and a trajectory generator that generates a target trajectory of the robot based on the position information specified by the specifier, the robot controller controls the robot in accordance with the target trajectory generated by the trajectory generator to cause the robot to treat an object.

An object detection method according to the present disclosure includes: detecting a surface of a polygon of a limited type from a two-dimensional image including an object, using a learned model learned by machine learning; and specifying position information concerning a three-dimensional position of the detected surface, based on three-dimensional information corresponding to the two-dimensional image.

The object detector can enhance accuracy of object detection.

The robot system can enhance accuracy of object detection.

The object detection method can enhance accuracy of object detection.

### BRIEF DESCRIPTION OF THE DRAWINGS

FIG. 1 is a schematic view illustrating a configuration of a robot system.

FIG. 2 is a view illustrating a schematic hardware configuration of a robot controller and an object detector.

FIG. 3 is a block diagram illustrating a configuration of a control system of a processor.

FIG. 4 is a flowchart showing a transfer process in the robot system.

FIG. 5 is an example of a two-dimensional image.

FIG. 6 is an example of three-dimensional information.

FIG. 7 shows a result of detection of surfaces of limited polygons in the two-dimensional image shown in FIG. 5.

FIG. 8 shows a result of specification of surfaces of limited polygons in the three-dimensional information shown in FIG. 6.

### DESCRIPTION OF EMBODIMENTS

An exemplary embodiment will be described in detail hereinafter with reference to the drawings.

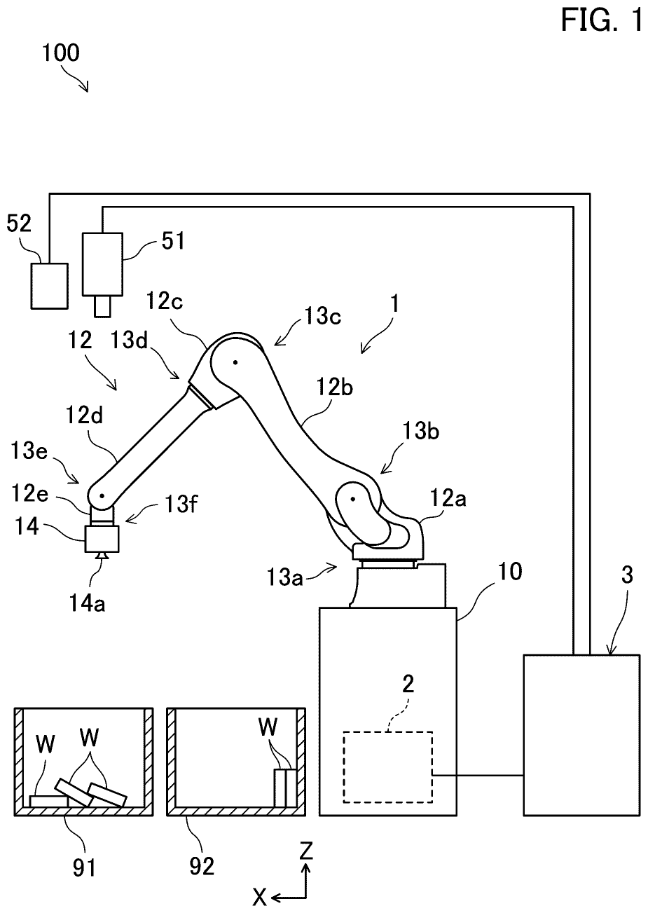

An exemplary embodiment will be described in detail hereinafter with reference to the drawings. FIG. 1 is a schematic view illustrating a configuration of a robot system 100.

The robot system 100 includes a robot 1, an object detector 3 that detects an object, and a robot controller 2 that controls the robot 1 based on a detection result by the object detector 3. The robot controller 2 controls the robot 1 to cause the robot 1 to treat the object. In this example, the process by the robot 1 is picking. For example, objects are loosely piled in a first container 91. The object detector 3 selects a target object W from the objects in the first container 91. The robot controller 2 controls the robot 1 based on a detection result by the object detector 3. The robot 1 picks up the target object W in the first container 91 and transfers the target object W into a second container 92. The robot 1 regularly arranges the target objects W in the second container 92. The robot system 100 repeatedly performs a process of selecting, picking, and arranging the target objects W to thereby arrange the target objects W from the first container 91 in the second container 92. The object detector 3 is an example of an object detection device.

The target object W has a specific shape. In this example, the target object W is a substantially rectangular parallelepiped. That is, the target object W has six surfaces of three types of substantially rectangles in total.

The robot system 100 includes a two-dimensional camera 51 as a first sensor that acquires a two-dimensional image of objects, a three-dimensional vision sensor 52 as a second sensor that acquires three-dimensional information of objects. The two-dimensional camera 51 and the three-dimensional vision sensor 52 are fixed above the first container 91.

The two-dimensional camera 51 captures a two-dimensional image in the first container 91 from above. The two-dimensional camera 51 acquires a two-dimensional image including objects in the first container 91. The three-dimensional vision sensor 52 acquires three-dimensional information in the first container 91. The three-dimensional vision sensor 52 acquires point group data of objects as the three-dimensional information of the objects in the first container 91. The two-dimensional camera 51 may also acquire a two-dimensional image of the first container 91. The three-dimensional vision sensor 52 may also acquire three-dimensional information of the first container 91.

The two-dimensional image and the three-dimensional information are associated with each other. That is, the position in the two-dimensional image corresponds to the position in the three-dimensional information. When the position on the two-dimensional image is specified, the corresponding position in the three-dimensional information is specified.

### Robot-In

this example, the robot 1 is an industrial robot. The robot 1 includes a robot arm 12. The robot arm 12 includes a hand 14 as an end effector. The robot arm 12 adsorbs an object with the hand 14.

In the space where the robot 1 is disposed, a robot coordinate system of three orthogonal axes is defined. For example, a Z axis is defined in the top-bottom directions, and an X axis and a Y axis are defined to be orthogonal to each other in the horizontal directions.

The robot arm 12 moves in three dimensions. Specifically, the robot arm 12 performs actions including a translation motion of at least three degrees of freedom. In this example, the robot arm 12 is a vertical articulated robot arm. The robot arm 12 is supported by a base 10. The robot arm 12 includes links, joints connecting the links, and a servo motor that rotationally drives the joints.

Specifically, the robot arm 12 includes a first link 12a coupled to the base 10, a second link 12b coupled to the first link 12a, a third link 12c coupled to the second link 12b, a fourth link 12d coupled to the third link 12c, and a fifth link 12e coupled to the fourth link 12d.

Specifically, the base 10 and the first link 12a are coupled to each other through a first joint 13a rotatable about an axis extending in the vertical direction. The first link 12a and the second link 12b are coupled to each other through a second joint 13b rotatable about an axis extending in the horizontal direction. The second link 12b and the third link 12c are coupled to each other through a third joint 13c rotatable about an axis extending in the horizontal direction. The third link 12c and the fourth link 12d are coupled to each other through a fourth joint 13d rotatable about an axial center of the fourth link 12d (i.e., about a direction in which the fourth link 12d extends). The fourth link 12d and the fifth link 12e are coupled to each other through a fifth joint 13e rotatable about an axis orthogonal to the axial center of the fourth link 12d.

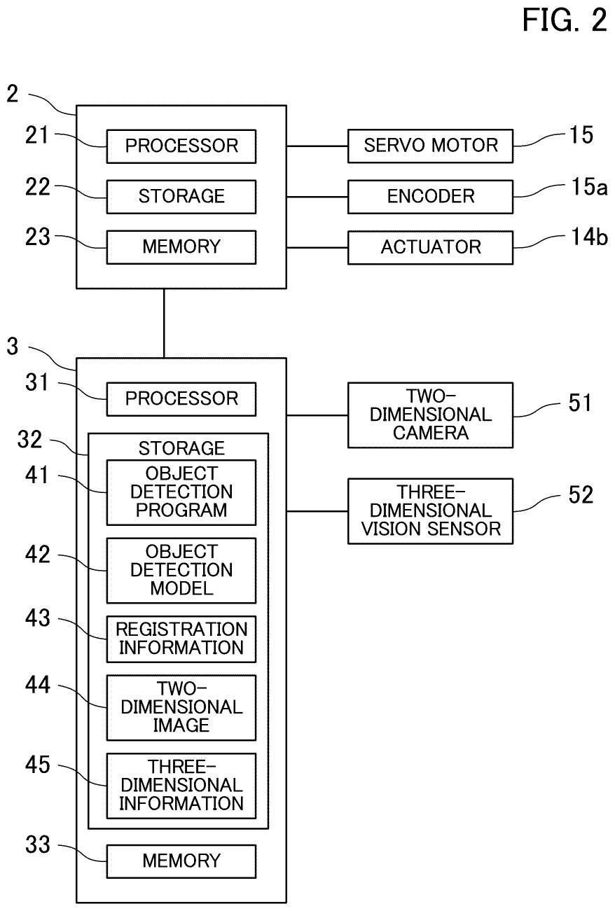

The robot arm 12 includes servo motors 15 (see FIG. 2) that rotationally drive the joints. Each of the servo motors 15 includes an encoder 15a (see FIG. 2).

The thus-configured robot arm 12 performs translation motions in the X-axis direction, the Y-axis direction, and the Z-axis direction, and rotation motions about the X axis, the Y axis, and the Z axis.

The hand 14 is coupled to a front end of the robot arm 12, that is, to the fifth link 12e. The fifth link 12e and the hand 14 are coupled to each other through a sixth joint 13f to be rotatable about a predetermined axis. The hand 14 includes an adsorber 14a. An air hose connected to a negative pressure source is connected to the adsorber 14a. The air hose includes a solenoid valve as an actuator 14b (see FIG. 2). The adsorber 14a is switched between adsorption by the adsorber 14a and release from the adsorber 14a, by controlling the solenoid valve. The adsorber 14a adsorbs a surface of the target object W.

### Robot Controller and Controller

FIG. 2 is a view illustrating a schematic hardware configuration of the robot controller 2 and the object detector 3. The object detector 3 transmits and receives signals, information, and others to/from the robot controller 2. The object detector 3 receives a two-dimensional image 44 from the two-dimensional camera 51 and three-dimensional information 45 from the three-dimensional vision sensor 52. The object detector 3 detects a target object W based on the two-dimensional image 44 and the three-dimensional information 45. In addition, the object detector 3 generates a target trajectory of the robot 1 based on the detected target object W, and outputs an instruction corresponding to the generated target trajectory to the robot controller 2. In response to the instruction from the object detector 3, the robot controller 2 controls the servo motor 15 and the hand 14 of the robot arm 12.

The robot controller 2 includes a processor 21, a storage 22, and a memory 23.

The processor 21 controls the entire robot controller 2. The processor 21 performs various computation processes. For example, the processor 21 is a processor such as a central processing unit (CPU). The processor 21 may be a micro controller unit (MCU), a micro processor unit (MPU), a field programmable gate array (FPGA), a programmable logic controller (PLC), or system LSI, for example.

The storage 22 stores programs and various types of data to be executed by the processor 21. The storage 22 may be, for example, a nonvolatile memory, a hard disc drive (HDD), or a solid state drive (SSD).

The memory 23 temporarily stores data or other information. For example, the memory 23 is a volatile memory.

The processor 21 drives the servo motor 15 based on an instruction value from the object detector 3. At this time, the robot controller 2 performs feedback control on a supply current to the servo motors 15 based on a detection result of the encoder 15a. The processor 21 controls the actuator of the hand 14 to switch the hand 14 between adsorption and release.

The object detector 3 includes a processor 31, a storage 32, and a memory 33.

The processor 31 controls the entire object detector 3. The processor 31 performs various computation processes. For example, the processor 31 is a processor such as a central processing unit (CPU). The processor 31 may be a micro controller unit (MCU), a micro processor unit (MPU), a field programmable gate array (FPGA), a programmable logic controller (PLC), or system LSI, for example.

The storage 32 stores programs and various types of data to be executed by the processor 31. The storage 32 may be, for example, a nonvolatile memory, a hard disc drive (HDD), or a solid state drive (SSD).

For example, the storage 32 stores an object detection program 41 and an object detection model 42 used for detecting an object. The object detection program 41 causes the object detector 3 to perform various functions and detect an object. The object detection model 42 is a learned model learned by machine learning. The storage 32 stores registration information 43 concerning an outer shape of a surface of an object as a detection target.

The registration information 43 is information for concretely specifying a shape of a surface of an object. For example, the registration information 43 includes at least one of a length of each side, each interior angle, or an area of a surface of an object as a detection target. In a case where a surface of an object as a detection target is a quadrangle, the registration information 43 may include an aspect ratio (i.e., a ratio of length to width). The registration information 43 may be a value or a range of a length of a side or the like. In this example, a target object W of picking (an object W to be picked up) is a substantially rectangular parallelepiped. The registration information 43 is information for concretely specifying a shape of a surface of a substantially rectangle. Specifically, the registration information 43 is a range of the length of each side, a range of each interior angle, a range of the area, a range of the aspect ratio, and so forth, of a surface assumed to be a substantially rectangular surface of the target object W.

The memory 33 temporarily stores data or the like. For example, the memory 33 is a volatile memory. The memory 33 stores the two-dimensional image 44 from the two-dimensional camera 51 and the three-dimensional information 45 from the three-dimensional vision sensor 52.

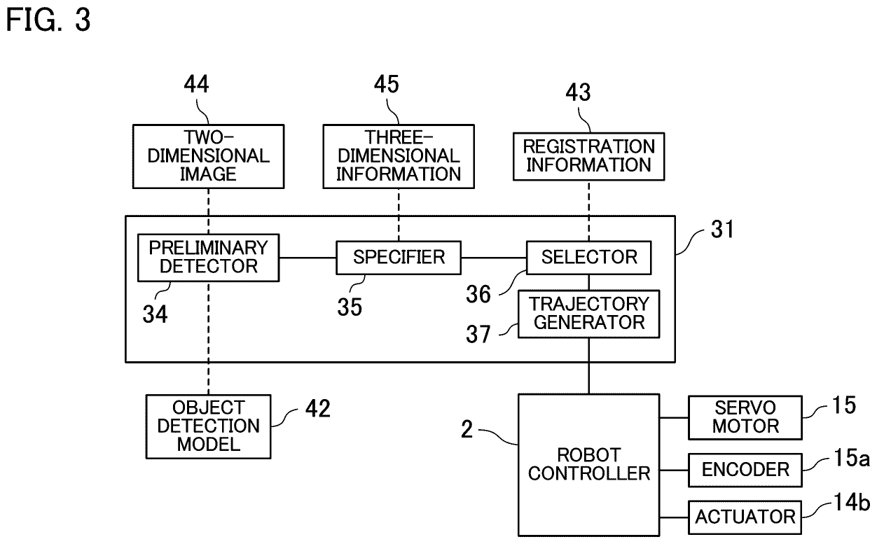

FIG. 3 is a block diagram illustrating a configuration of a control system of the processor 31. The processor 31 reads the object detection program 41 from the storage 32 and develops the detection program 41 to the memory 33 to thereby perform various functions. Specifically, the processor 31 functions as a preliminary detector 34, a specifier 35, a selector 36, and a trajectory generator 37.

The preliminary detector 34 detects a surface of a polygons of a limited type from the two-dimensional image 44 including objects, using the object detection model 42 learned by machine learning. The “type” of a polygon herein refers to the number of vertices of the polygon, that is, how many sides the polygon has. The preliminary detector 34 does not specify an interior angle of each vertex and a length of each side of a polygon. That is, the preliminary detector 34 detects a surface of a polygon of a limited type and having any interior angle of each vertex and any length of each side. Hereinafter, a polygon of a limited type will be referred to as a “limited polygon.” The type of the polygon limited by the preliminary detector 34 coincides with the type of a surface of an object to be detected. In this example, the object to be detected has three types of surfaces, and all the three types are quadrangles. Thus, the type of the polygon limited by the preliminary detector 34 is a quadrangle. That is, the preliminary detector 34 detects a surface of a quadrangle with any interior angle of each vertex and any length of each side, from the two-dimensional image 44. The preliminary detector 34 detects a polygon in the two-dimensional image 44, as a surface of the polygon.

The object detection model 42 detects a surface of a limited polygon, using the two-dimensional image 44 as an input. In a case where the two-dimensional image 44 includes surfaces of limited polygons, the object detection model 42 may detect surfaces of limited polygons. The object detection model 42 performs image recognition. The object detection model 42 outputs, as a detection result of a surface of a limited polygon, information for specifying a position and a shape of the limited polygon. For example, the information for specifying a position and a shape of a limited polygon is a position of a centroid and a position of each vertex of the limited polygon in a local coordinate system (e.g., camera coordinate system) corresponding to the two-dimensional image 44. The position of each vertex may be, for example, a length of a perpendicular from the centroid to each side, a direction of each perpendicular (i.e., angle of each perpendicular about the centroid), a length of each side, and so on. Further, the object detection model 42 may also output a confidence score of detection of a limited polygon.

The object detection model 42 is a learned model by learned by machine learning as described above. The learned model is also called artificial intelligence (AI), a classifier, or a classification learner. Machine learning may use various known techniques, and may be, for example, reinforcement learning or deep learning. The object detection model 42 includes a neural network. The neural network may be a convolutional neural network (CNN).

The preliminary detector 34 inputs the two-dimensional image 44 to the object detection model 42. The preliminary detector 34 may perform processing such as trimming on the two-dimensional image 44 before inputting the two-dimensional image 44 to the object detection model 42. For example, the preliminary detector 34 trims a region including the first container 91 from the two-dimensional image 44.

The preliminary detector 34 removes some limited polygons from limited polygons detected by the object detection model 42. For example, the preliminary detector 34 removes redundant limited polygons by non-maximum suppression (NMS). Specifically, the preliminary detector 34 keeps one limited polygon with a high confidence score from overlapping limited polygons whose intersection over union (IoU) exceeds a predetermined threshold, and removes the other limited polygons. Alternatively, the preliminary detector 34 keeps one limited polygon from limited positions whose centroid positions are close to each other with a distance less than a predetermined threshold, and removes the other limited polygons. In addition, the preliminary detector 34 removes limited polygons whose confidence scores are less than a predetermined threshold from the detected limited polygons. In this manner, the preliminary detector 34 reduces the number of limited polygons that are finally output.

The specifier 35 specifies position information concerning a three-dimensional position of a surface detected by the preliminary detector 34, based on the three-dimensional information 45 corresponding to the two-dimensional image 44. The position in the two-dimensional image 44 corresponds to the position in the three-dimensional information 45. That is, the position in the two-dimensional image 44 uniquely corresponds to the position in the three-dimensional information 45. The specifier 35 extracts a point group corresponding to a surface of a limited polygon detected by the preliminary detector 34 from the three-dimensional information 45. Specifically, the preliminary detector 34 outputs a two-dimensional position of the surface of the limited polygon to the specifier 35. The specifier 35 extracts a point group of positions corresponding to two-dimensional positions of the surface of the limited polygon in the three-dimensional information 45, as a point group corresponding to the surface of the limited polygon. The specifier 35 approximates the point group corresponding to the surface of the limited polygon to a three-dimensional plane to thereby specify three-dimensional position information of the surface of the limited polygon. For example, the three-dimensional position information is information concerning a three-dimensional position and a three-dimensional posture of the surface of the limited polygon. For example, the three-dimensional position information includes at least one of a three-dimensional position of the centroid, a normal direction of the surface, a three-dimensional position of each vertex, or a length of each side of the limited polygon. In this example, the specifier 35 specifies, as the three-dimensional position information, all the three-dimensional position of the centroid, the normal direction of the surface, the three-dimensional position of each vertex, and the length of each side of the limited polygon.

In this example, the specifier 35 removes points with large deviations as outliers from the point group corresponding to the surface of the limited polygon and performs plane approximation. For example, the specifier 35 may obtain a provisional approximate plane using the point group corresponding to the surface of the limited polygon, regard points at which deviations from the provisional approximate plane are greater than or equal to a predetermined value as outliers, and determine a final approximate plane from the point group excluding the outliers. Accordingly, detection accuracy of the three-dimensional position of the surface of the limited polygon is enhanced.

The selector 36 select a surface of a target object W from surfaces of which the position information is specified by comparing the position information specified by the specifier 35 with the registration information 43 stored in the storage 32. Specifically, the selector 36 determines whether the surface of the limited polygon in which the three-dimensional position information is specified by the specifier 35 matches the registration information 43 or not. The specifier 35 specifies a three-dimensional position of the surface of the limited polygon. The storage 32 stores the registration information 43 concerning an outer shape of a surface of a target object W. For example, in a case where a length of each side, an area, an interior angle of each vertex, and an aspect ratio of the specified surface of the limited polygon are included in the length of each side, the area, the interior angle of each vertex, and the aspect ratio in the registration information 43, the selector 36 determines that the surface of the limited polygon matches the registration information 43. The selector 36 selects, as a surface of a target object W, a surface of the limited polygon that matches the registration information 43, from surfaces of limited polygons of which the position information is specified by the specifier 35. Here, the selection of the surface of the target object W is only estimation. Therefore, the selection of the surface of the target object W can also be rephrased as the selection of a candidate surface for the surface of the target object W or the selection of a possible surface for the surface of the target object W.

The selector 36 may select a surface based on environment conditions and others, as well as selection of a surface based on the registration information 43. The environment conditions and others are, for example, accuracy and imaging environments of the two-dimensional camera 51 and the three-dimensional vision sensor 52, properties of a surface of an object, the size of the first container 91, and a movable range of the robot arm 12.

Specifically, the selector 36 may select a surface from surfaces of limited polygons specified by the specifier 35, based on a variation of a point group included in each surface. For example, the selector 36 may exclude a surface in which variations of the point groups are greater than or equal to a predetermined threshold from specified surfaces of limited polygons, and select a surface in which variations of the point groups are less than the predetermined threshold as a surface of a target object W. The variation of the point group is a variation of a point group used to calculate an approximate plane with respect to the approximate plane obtained by the specifier 35. This is selection based on the accuracy and imaging environments of the two-dimensional camera 51 and the three-dimensional vision sensor 52 and the properties of the surface of the object.

The selector 36 may select a surface from surfaces of limited polygons specified by the specifier 35 based on the missing amount (i.e., the number of missing points) of each surface. The missing point is a point missing in a surface of a limited polygon, and corresponds to a point excluded as the outlier as described above, for example. Further, depending on situations where the three-dimensional vision sensor 52 acquires the three-dimensional information 45, a missing point may be present in the three-dimensional information 45 from the beginning, in some cases. For example, the selector 36 may exclude a surface in which the missing amounts are greater than or equal to a predetermined threshold from specified surfaces of limited polygons, and select a surface in which the missing amounts are smaller than the threshold, as a surface of a target object W. This is selection based on the accuracy and imaging environments of the two-dimensional camera 51 and the three-dimensional vision sensor 52 and the properties of the surface of the object.

The selector 36 may select a surface from surfaces of limited polygons specified by the specifier 35 based on the position of the surface. For example, the selector 36 may exclude a surface that is not inside the first container 91 from the specified surfaces of limited polygons, and select a surface that is inside the first container 91 as a surface of a target object W. This is selection based on the size of the first container 91.

Further, the selector 36 may select a surface from surfaces of limited polygons specified by the specifier 35 based on the normal direction of the surfaces. For example, the selector 36 may exclude a surface of which the inclination of the normal direction with respect to a predetermined reference direction is greater than or equal to a predetermined threshold from specified surfaces of limited polygons, and select a surface in which the inclination of the normal direction is less than the threshold, as a surface of a target object W. For example, the reference direction is the opening direction of the first container 91, that is, the imaging direction. The robot arm 12 accesses the target object W from the opening of the first container 91, and thus, a surface that faces in directions significantly different from the opening direction of the first container 91 is not suitable as a surface of the target object W to be picked up. Therefore, the selector 36 selects a surface with a small inclination of the normal direction with respect to the reference direction. This is selection based on the orientation of the surface.

The selector 36 may select a surface from surfaces of limited polygons specified by the specifier 35 based on whether the robot arm 12 can access the surface or not. For example, the selector 36 may exclude a surface that the robot arm 12 accesses while interfering with the first container 91, and select a surface that the robot arm 12 can access without interfering with the first container 91 as a surface of a target object W. This is selection based on the movable range of the robot arm 12.

Finally, the selector 36 outputs three-dimensional position information of the selected surface of the target object W, that is, a three-dimensional position of the centroid of the surface, the normal direction of the surface, the three-dimensional position of each vertex, and the length of each side.

The selector 36 may select multiple surfaces of the target object W. In the case where the selector 36 selects multiple surfaces, the selector 36 may assign the selected surfaces with priorities. The priority may be the order of reliability of selection of the surfaces of the target object W. Alternatively, the priority may be set in relation to a subsequent process (picking in this example). For example, the selector 36 may assign higher priority to the selected surfaces in ascending order of the missing amount described above. The selector 36 may assign higher priority to the selected surfaces in ascending order of the degree of variation of the point group described above. The selector 36 may assign higher priority to the selected surfaces in order of proximity to the normal direction described above to the vertically upper side.

The trajectory generator 37 generates a target trajectory of the robot arm 12 where the robot arm 12 picks up a target object W from the first container 91 based on three-dimensional position information on the surface selected by the selector 36, and arranges the target object W in the second container 92.

In a case where the selector 36 outputs multiple surfaces, the trajectory generator 37 selects one surface from the surfaces. That is, the trajectory generator 37 selects one surface to be adsorbed by the hand 14 from the surfaces. For example, the trajectory generator 37 selects one surface that is the most accessible by the robot arm 12 or one surface that will shorten the cycle time. More specifically, the trajectory generator 37 selects one surface from the surfaces in terms of accessibility, and in a case where it is impossible to select one surface in terms of accessibility, the trajectory generator 37 selects one surface in terms of reduction of the cycle time. Alternatively, in a case where the object is a rectangular parallelepiped and three types of surfaces of the rectangular parallelepiped are assigned with priorities, the trajectory generator 37 selects one surface with the highest priority from the surfaces. For example, the three types of surfaces of the rectangular parallelepiped may be assigned with priorities in descending order of area.

The trajectory generator 37 generates a target trajectory of the robot arm 12 for allowing the hand 14 to adsorb the selected surface and transferring the hand 14 to a predetermined position of the second container 92. At this time, the trajectory generator 37 generates a target trajectory in which the robot arm 12 does not interfere with the first container 91 and the second container 92. The trajectory generator 37 generates an instruction value in accordance with a rotation angle of each joint of the robot arm 12 for obtaining the target trajectory, and outputs the generated instruction value to the robot controller 2.

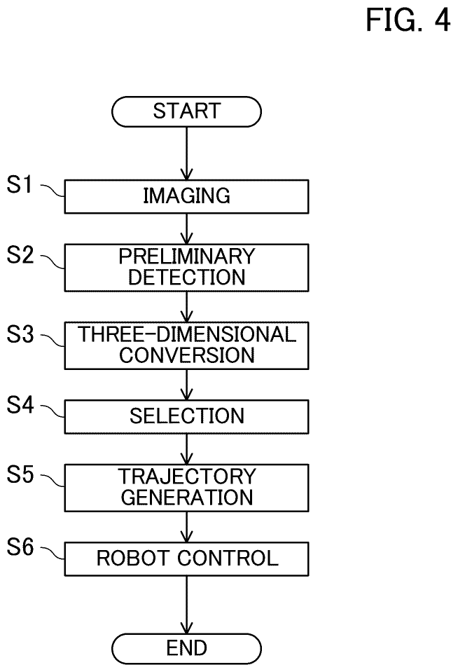

An action of the thus-configured robot system 100 will now be described. FIG. 4 is a flowchart showing a transfer process in the robot system 100. In this example, the robot system 100 picks up a substantially rectangular parallelepiped target object W contained included in the first container 91, and transfers the target object W to the second container 92.

First, in step S1, the object detector 3 acquires the two-dimensional image 44 by the two-dimensional camera 51, and acquires the three-dimensional information 45 by the three-dimensional vision sensor 52. The two-dimensional camera 51 captures the two-dimensional image 44 of the inside of the first container 91 including the first container 91, from above the first container 91. The three-dimensional vision sensor 52 acquires the three-dimensional information 45 of the inside of the first container 91 including the first container 91, from above the first container 91.

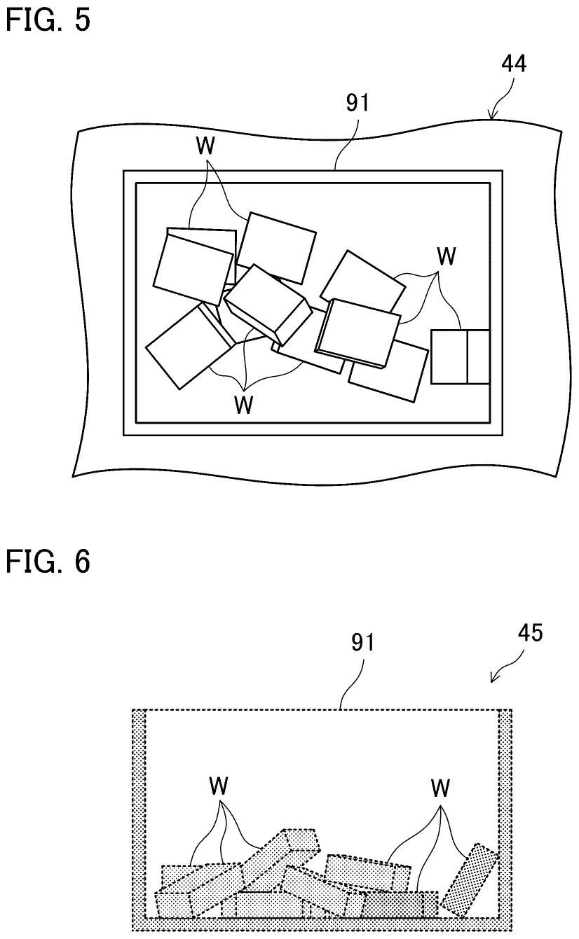

FIG. 5 is an example of the two-dimensional image 44. FIG. 6 is an example of the three-dimensional information 45. The two-dimensional image 44 is a so-called planar image. FIG. 6 shows a state where a point group as the three-dimensional information 45 is seen from a side. The point group as the three-dimensional information 45 has a three-dimensional expansion. Each of the two-dimensional image 44 and the three-dimensional information 45 includes objects and the first container 91.

Next, in step S2, the object detector 3 detects a surface of a limited polygon from the two-dimensional image 44. In this example, the limited polygon is a quadrangle. The preliminary detector 34 detects a surface of a quadrangle having any size of each interior angle and any length of each side from the two-dimensional image 44. At this time, the preliminary detector 34 removes unnecessary or inappropriate limited polygons from the detected limited polygons. Step S2 corresponds detecting a surface of a polygon of a limited type from a two-dimensional image including an object, using a learned model learned by machine learning.

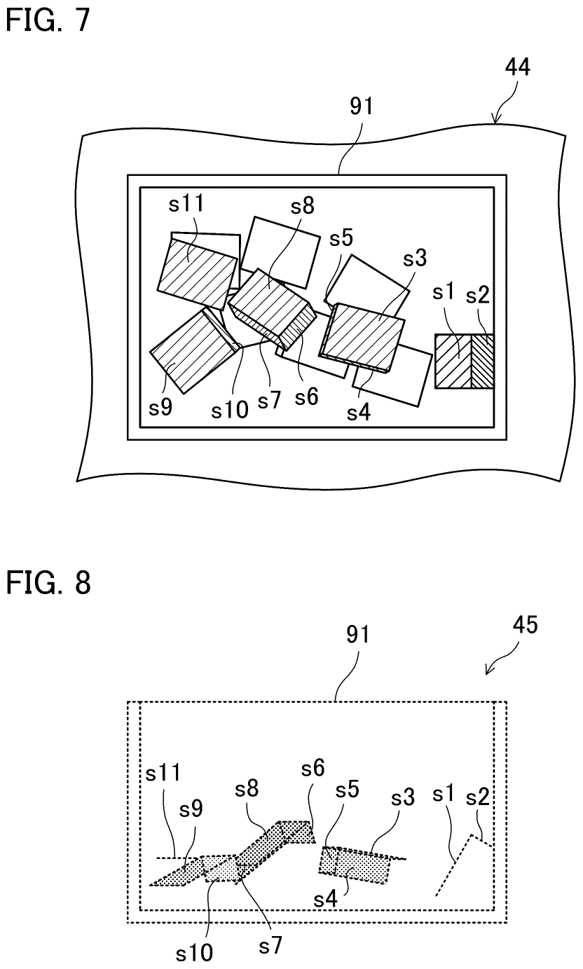

FIG. 7 shows a result of detection of surfaces of limited polygons in the two-dimensional image 44 shown in FIG. 5. The preliminary detector 34 detects surfaces s of quadrangles included in the two-dimensional image 44. In FIG. 7, numbers are attached after reference character “s” to identify individual surfaces. When the surfaces are not distinguished from each other, these surfaces are simply referred to as “surfaces s.” Surfaces s1, s2, s9, s10, and s11 are surfaces of substantially rectangles. Surfaces s3, s4, s5, s6, s7, and s8 are surfaces of substantially parallelograms. All the objects included in the first container 91 are target objects W of substantially rectangular parallelepipeds. All the surfaces of the target object W are substantially rectangles. However, due to the relationship between the imaging direction and the normal direction of the surface, a surface of the target object W in the two-dimensional image 44 may have a shape different from an actual shape thereof. Thus, as illustrated in FIG. 7, the surfaces s detected by the preliminary detector 34 are substantially rectangles or substantially parallelograms. Depending on the depth in the imaging direction, the surfaces of the target objects W can also be trapezoids. The surfaces s detected by the preliminary detector 34 may include a trapezoidal surface and may also include a surface of a quadrangle that is not classified as a rectangle, a parallelogram, or a trapezoid.

Subsequently, in step S3, the object detector 3 converts a surface s of a two-dimensional limited polygon to a surface of a three-dimensional limited polygon. That is, the specifier 35 extracts a point group corresponding to two-dimensional positions of the surfaces s of the limited polygons detected by the preliminary detector 34, from the three-dimensional information 45. The specifier 35 specifies three-dimensional position information (i.e., three-dimensional position and posture) of the surfaces s of the limited polygons by performing plane approximation on the extracted point group. Step S3 corresponds to specifying position information concerning a three-dimensional position of the detected surface based on three-dimensional information corresponding to the two-dimensional image.

FIG. 8 shows a result of specification of surfaces of limited polygons in the three-dimensional image 45 shown in FIG. 6. The specifier 35 extracts a point group corresponding to the surfaces s from the three-dimensional information 45. Character “s” and its subscripts in FIG. 8 correspond to the surfaces in FIG. 7. The specifier 35 obtains an approximate plane from the point group corresponding to the surfaces s.

Further, in step S4, the object detector 3 selects a surface of target objects W from the surfaces s of the limited polygons in which three-dimensional position information is specified. Specifically, the selector 36 compares the specified three-dimensional position information of the limited polygons with the registration information 43 and determines whether the surfaces are surfaces of target objects W or not. The selector 36 determines whether the length of each side, the size of each interior angle, the area, and the aspect ratio of the limited polygons specified based on the three-dimensional position information match the registration information 43 or not, and selects a matching surface of the limited polygon as a surface of a target object W. The number of selected surfaces is not limited to one, and may be plural.

In the two-dimensional image 44, a surface that is not the surface of the target object W but correspond to limited polygons may be detected by the preliminary detector 34. Such a surface is determined not to be a surface of a target object W by specifying the three-dimensional position information specified by the specifier 35 and comparing the three-dimensional information with the registration information 43 by the selector 36. That is, even if the preliminary detector 34 detects a surface other than the surface of a target object W, the selector 36 excludes the surface other than the surface of the target objects W and selects the surface of the target objects W.

In this example, the selector 36 further selects a surface based on environment conditions and others (e.g., a variation of the point group, the missing amount of the point group, or the normal direction of the surface). For example, in the examples of FIGS. 7 and 8, the selector 36 considers orientation of the normal direction of the surface and access of the robot arm 12 and others and selects the surfaces s3 and s8 are selected as surfaces of target objects W.

Thereafter, in step S5, the object detector 3 generates a target trajectory of the robot arm 12 based on the selected surface. Specifically, the trajectory generator 37 generates a target trajectory of the robot arm 12 for picking up a target object W with the selected surface and transferring the target object W to the second container 92. In a case where multiple surfaces are selected by the selector 36, the trajectory generator 37 selects one surface from the surfaces. For example, in the examples of FIGS. 7 and 8, the trajectory generator 37 selects one surface from the selected surfaces s3 and s8. The trajectory generator 37 outputs an instruction value corresponding to the generated target trajectory to the robot controller 2.

In step S6, the robot controller 2 controls the servo motors 15 and others based on the instruction value from the trajectory generator 37 to operate the robot arm 12. As a result, the robot arm 12 picks up the target object W with the selected surface and arranges the target object W in the second container 92. Specifically, the robot arm 12 adsorbs the selected surface by the hand 14.

The robot system 100 repeats the above process to thereby transfer the target objects W from the first container 91 to the second container 92 and arrange the target objects W in the second container 92. The robot system 100 continues to transfer target objects W until there are no target objects W left in the first container 91 or until the number of target objects W transferred to the second container 92 reaches a predetermined number.

In the manner described above, the object detector 3 detects a surface from the two-dimensional image 44 by using the object detection model 42 and specifies three-dimensional information of the detected surfaces based on the three-dimensional information. At this time, the preliminary detector 34 detects not surfaces of various types of polygons but a surface of a limited type of a polygon from the two-dimensional image 44, using the object detection model 42. For example, in a situation where objects are loosely piled, there are some surfaces whose normal directions are not aligned with the imaging direction. Surfaces whose normal directions are not alighted with the imaging direction are represented in shapes different from actual shapes thereof in the two-dimensional image 44. That is, the size of each interior angle, the length of each side, or the like in the two-dimensional image 44 may vary depending on orientation of the normal direction of the surface and other factors. If it is assumed that surfaces of polygons with various shapes are detection targets, an annotation load for machine learning of the object detection model 42 increases, which might lead to a decrease in learning efficiency. On the other hand, in the two-dimensional image 44, even if the sizes of the interior angle and others change, the types of polygons do not change. Therefore, the preliminary detector 34 limits the type of a polygon of a surface to be detected from the two-dimensional image 44, thereby excluding surfaces with a low possibility of being an object surface from the detection targets and narrowing the range of the detection targets. As a result, the object detection model 42 can be learned efficiently, and detection accuracy can be enhanced.

However, simply limiting the types of polygons may allow the object detector 3 to detect surfaces that are not surfaces of target objects W. In view of this, the specifier 35 specifies three-dimensional position information of the surface detected by the preliminary detector 34 based on the three-dimensional information 45. By specifying the three-dimensional position information of the surface, it becomes easier to determine whether the detected surface is a surface of a target object W or not.

Further, the object detector 3 selects an appropriate surface by comparing the three-dimensional position information of the surface with the registration information 43. That is, with the two-dimensional image 44, the size of each interior angle and the length of each side of the surface cannot be properly evaluated. However, by specifying the three-dimensional position information of the surface, the size of each interior angle and others of the surface can be evaluated. As the registration information 43, the size of each interior angle, the length of each side, the aspect ratio, and the area are set in the form of values or ranges. The selector 36 selects the surface of the target object W by comparing the three-dimensional position information of the specified surfaces with the registration information 43. In this manner, the object detector 3 can accurately detect the surface of the target object W.

### Other Embodiments

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

For example, the object detector 3 is not limited to a detector incorporated in the robot system 100. The object detector 3 may simply detect a surface of an object independently of the robot 1.

The object detector 3 may not include the trajectory generator 37, that is, may not generate a target trajectory of the robot 1. The object detector 3 may simply detect a surface an object and output a detection result. External equipment may generate a target trajectory of the robot 1 based on the detection result of the object detector 3.

The object detector 3 may not include the selector 36. The object detector 3 may simply specify three-dimensional position information of a surface detected from the two-dimensional image 44 based on the three-dimensional information 45 and output three-dimensional position information of the surface.

The robot system 100 incorporating the object detector 3 is not limited to the system that transfers target objects W detected by the object detector 3 from the first container 91 to the second container 92. For example, the robot 1 may execute devanning. Alternatively, the process performed by the robot 1 is not limited to picking. The process performed by the robot 1 may be, for example, coating, cutting, and other processes. That is, the object detector 3 detects a surface of an object for executing a process such as coating or cutting.

The robot 1 may be a robot including no robot arm, for example, a self-propelled robot. The robot arm 12 is not limited to a vertical articulated robot arm. The robot arm 12 may be of a horizontal articulated type, a parallel link type, a Cartesian coordinate type, a polar coordinate type, or other types.

The hand 14 may be of a grip type rather than the adsorption type. That is, the hand 14 may include fingers that can be opened and closed and hold an object with the fingers. In the case where the hand 14 is of the grip type, the trajectory generator 37 generates a target trajectory such that the hand 14 holds a selected target object W with the hand 14 facing a surface of the target object W.

The object detector 3 may detect a target object W from aligned objects rather than objects that are loosely piled. The object detector 3 may detect a target object W from not only objects in a container but also objects placed on a conveyor or the like. Target objects whose surfaces are to be detected by the object detector 3 are not limited to rectangular parallelepipeds. As long as the target objects have polygonal surfaces, any objects can be applied. For example, the target object may have a substantially triangular prism shape. In this case, the target object includes three substantially rectangular surfaces and two substantially triangular surfaces. The preliminary detector 34 may set at least one of a triangle or a quadrangle as a limited polygon. The registration information 43 is information for identifying the shape of a surface of a polygon corresponding to the type limited by the preliminary detector 34.

The device for acquiring the two-dimensional image 44 is not limited to the two-dimensional camera 51. The device for acquiring the three-dimensional information 45 is not limited to the three-dimensional vision sensor 52. For example, three-dimensional information 45 may be acquired by an RGB-D camera that outputs RGB-D images, a stereo camera that acquires RGB images, or the like. In this case, the RGB-D camera or the like may capture the two-dimensional image 44 in addition to the three-dimensional information 45. The three-dimensional information 45 may be a depth image, a voxel, and others as well as point group data, an RGB-D image, an RGB image.

The two-dimensional image 44 and the three-dimensional information 45 that are referred to by the object detector 3 are not necessarily acquired by the two-dimensional camera 51 and three-dimensional vision sensor 52, respectively. The two-dimensional image 44 or the three-dimensional information 45 may be input to the object detector 3 from the outside. In this case, the method of acquiring the two-dimensional image 44 or the three-dimensional information 45 is not particularly limited. The two-dimensional image 44 and the three-dimensional information 45 input from the outside may be stored in the memory 33 or in the storage 32.

The two-dimensional camera 51 or the three-dimensional vision sensor 52 may not be fixed, and may be attached to the robot arm 12. In this case, in the imaging in step S1, the two-dimensional camera 51 or the three-dimensional vision sensor 52 is moved to a predetermined imaging position by the robot arm 12.

The processes performed by the preliminary detector 34, the specifier 35, the selector 36, and the trajectory generator 37 are merely examples. The preliminary detector 34 may detect a surface of a polygon of a limited type from the two-dimensional image 44 by any method. The type of polygon limited by the preliminary detector 34 may be one type or two or more types. The detection result of the preliminary detector 34 is not limited to the position of the centroid and the position of each vertex of a limited polygon, as long as the detection result specifies the position and shape of the limited polygon. The object detection model 42 may be any learned model. The neural network of the object detection model 42 is not limited to a convolutional neural network. The removal of redundant limited polygons by non-maximum suppression or the like by the preliminary detector 34 is not essential. The object detection model 42 may also use the three-dimensional information 45 as an input in addition to the two-dimensional image 44. Further, the preliminary detector 34 can also detect a limited polygon that is partially hidden in the two-dimensional image 44. For example, the preliminary detector 34 can also detect a limited polygon in which all the vertices can be recognized even if one or more sides are partially hidden by other objects.

The specifier 35 may specify three-dimensional position information of the surface detected by the preliminary detector 34 by any method based on the three-dimensional information 45. The specifier 35 may specify three-dimensional position information of the surface without excluding outliers from the point group corresponding to the surface of the limited polygon. The three-dimensional position information output by the specifier 35 is not limited to the three-dimensional position of the centroid, the normal direction of the surface, the three-dimensional position of each vertex, and the length of each side of the limited polygon, as long as the three-dimensional position information is information concerning the three-dimensional position and posture of the surface.

The selector 36 may select a surface of a target object W by any method by comparing the three-dimensional position information of the surface specified by the specifier 35 with the registration information 43. The registration information 43 is not limited to the length of each side, the area, the interior angle of each vertex, and the aspect ratio as long as the registration information 43 is information for concretely specifying the shape of a surface of an object. The registration information 43 may be information for concretely specifying the shape of at least one surface among surfaces of a target object W. For example, in a case where the target object W is a substantially rectangular parallelepiped with three types of surfaces, the registration information 43 may be information for concretely specifying the shape of one type of surface among the three types. In this case, the selector 36 selects a specific type of surface rather than any surface of the target object W.

In a case where multiple surfaces of the target object W are selected, the selector 36 may select one surface of the target object W from among the selected surfaces. For example, the selector 36 may select one surface to be adsorbed from the selected surfaces, as performed by the trajectory generator 37 described above.

The flowchart is merely an example. The steps in the flowchart may be changed, replaced, added, omitted, or the like as appropriate. Further, the order of steps in the flowchart may be changed or serial processings may be performed in parallel. For example, in the case where the two-dimensional image 44 and the three-dimensional information 45 are input to the object detector 3 from the outside, the imaging in step S1 is omitted.

Functions performed by constitutional elements described herein may be implemented in circuitry or processing circuitry including a general-purpose processor, an application-specific processor, an integrated circuit, an application specific integrated circuit (ASIC), a central processing unit (CPU), conventional circuitry, and/or a combination thereof programmed to perform the functions described herein. A processor includes transistors and other circuits, and is regarded as circuitry or arithmetic circuitry. A processor may be a programmed processor that performs programs stored in a memory.

Circuitry, a unit, and means herein are hardware that is programmed to perform or performs the described functions. The hardware may be any hardware disclosed herein, or any hardware programmed or known to perform the functions described.

If the hardware is a processor considered to be of a type of circuitry, the circuitry, means, or a unit is a combination of hardware and software used to configure the hardware and/or the processor.

### Aspects

The embodiments described above are specific examples of the following aspects.

(Aspect 1) An object detector 3 (object detection device) includes: a preliminary detector 34 that detects a surface of a polygon of a limited type from a two-dimensional image 44 including an object, using a learned model learned by machine learning, that is, an object detection model 42; and a specifier 35 that specifies position information concerning a three-dimensional position of the surface detected by the preliminary detector 34, based on three-dimensional information 45 corresponding to the two-dimensional image 44.

In this configuration, the preliminary detector 34 detects the surface of the polygon from the two-dimensional image 44 using the object detection model 42, and the specifier 35 specifies the three-dimensional position information of the detected surface based on the three-dimensional information 45. In this manner, the three-dimensional position information of the surface of the object is specified based on the two-dimensional image 44 and the three-dimensional information 45. At this time, the object detection model 42 detects not a surface of a polygon of any type but a surface of a polygon of a limited type. Thus, an annotation load in leaning of the object detection model 42 is reduced. As a result, the object detection model 42 can be learned efficiently, and detection accuracy can be enhanced.

(Aspect 2) The he object detector 3 of aspect 1 further includes: a storage 32 that stores registration information 43 concerning an outer shape of a surface of a target object W; and a selector 36 that selects the surface of the target object W from surface of which the position information is specified by comparing the position information specified by the specifier 35 with the registration information 43 stored in the storage 32.

In this configuration, the selector 36 select the surface of the target object W by comparing the three-dimensional position information of the surface specified by specifier 35 with the registration information 43, thereby further enhancing detection accuracy of the surface of the object. That is, since the preliminary detector 34 detects a two-dimensional surface from the two-dimensional image 44, the preliminary detector 34 might detect a surface of a polygon that is not a surface of a target object W. However, the specifier 35 specifies the three-dimensional position information based on the three-dimensional information 45. When the three-dimensional position information of the surface is specified, it becomes possible to detect whether the detected surface matches the registration information 43 concerning an outer shape of the target object W or not. That is, by comparing the three-dimensional position information of the surface with the registration information 43 by the selector 36, the surface of the target object W can be appropriately selected. As a result, the surface of the target object W can be accurately detected.

In particular, in a situation where the normal directions of surfaces of objects are dispersed, such as a situation where objects are loosely piled, the size of each interior angle, the length of each side, the area, or the like of each surface of objects in a two-dimensional image can change variously. Thus, the preliminary detector 34 detects a surface of a polygon that is of a limited type and has any size of each interior angle and the like to thereby detect surfaces that are deformed variously while limiting the surface of the detection target. Accordingly, while detecting a wide range of variously deformed surfaces of a target object W from the two-dimensional image 44, the preliminary detector 34 may detect a surface that is not a surface of the target object W. In view of this, the specifier 35 specifies the three-dimensional position information of the detected surface, and the selector 36 compares the three-dimensional position information of the surface with the registration information 43, thereby selecting an appropriate surface of the target object W. Accordingly, the surface of the target object W can be appropriately detected, independently of orientation of the normal directions of surfaces of objects.

(Aspect 3) In the object detector 3 of aspect 1 or aspect 2, the registration information 43 is information concerning at least one of a size of an interior angle, a length of a side, or an area, of the surface of the target object W.

In this configuration, it is possible to determine whether or not the surface detected by the preliminary detector 34 matches at least one of the size of the interior angle, the length of the side, or the area defined in the registration information 43, based on the three-dimensional position information specified by the specifier 35.

(Aspect 4) In the object detector 3 of any one of aspects 1 to 3, the specifier 35 approximates the surface detected by the preliminary detector 34 to a three-dimensional plane based on the three-dimensional information 45, and the selector 36 selects the surface of the target object W from the surfaces of which the position information is specified, based on a variation of the three-dimensional information 45 with respect to the plane.

In this configuration, it is possible to determine whether or not the surface detected by the preliminary detector 34 is selected as the surface of the target object W, in accordance with accuracy of a corresponding region in the three-dimensional information 45. For example, depending on properties of the surface of the object or situations where the three-dimensional information 45 is acquired, accuracy of the three-dimensional information 45 of the surface of the object might be low. With a low accuracy of the three-dimensional information 45, accuracy in selecting the surface based on the registration information 43 can decrease. In view of this, the selector 36 considers a variation of the three-dimensional information 45 with respect to the plane approximated by the specifier 35 to thereby accurately select the surface of the target object W.

(Aspect 5) In the object detector 3 of any one of aspects 1 to 4, the selector 36 selects the surface of the target object W from the surfaces of which the position information is specified, based on a missing amount of the three-dimensional information in a region corresponding to the surface detected by the preliminary detector 34.

In this configuration, it is possible to determine whether or not the surface detected by the preliminary detector 34 is selected as the surface of the target object W, in accordance with the missing amount of a corresponding region in the three-dimensional information 45. For example, depending on properties of the surface of the object or situations where the three-dimensional information 45 is acquired, a missing point might partially occur in acquiring the three-dimensional information 45. With a large missing amount of the three-dimensional information 45, accuracy in selecting the surface based on the registration information 43 can decrease. In view of this, the selector 36 considers the missing amount of the three-dimensional information 45 to thereby accurately select the surface of the target object W.

(Aspect 6) In the object detector 3 of any one of aspects 1 to 5, the selector 36 selects the surface of the target object W from the surfaces of which the position information is specified, based on normal directions of the surfaces specified from the position information.

In this configuration, it is possible to determine whether or not the surface detected by the preliminary detector 34 is selected as the surface of the target object W, in accordance with the normal directions of the surfaces obtained from the three-dimensional information. Processes after detection of the surface of the target object W may include a process in which the normal direction of the surface is important. The selector 36 considers the normal directions of the surfaces to thereby appropriately select the surface of the target object W.

(Aspect 7) A robot system 100 includes: a robot 1; an object detector 3 that detects an object; and a robot controller 2 that controls the robot 1, the object detector 3 includes a preliminary detector 34 that detects a surface of a polygon of a limited type from a two-dimensional image 44 including an object, using a learned model learned by machine learning, that is, an object detection model 42, a specifier 35 that specifies position information concerning a three-dimensional position of the surface detected by the preliminary detector 34, based on three-dimensional information 45 corresponding to the two-dimensional image 44, and a trajectory generator 37 that generates a target trajectory of the robot 1 based on the position information specified by the specifier 35, and the robot controller 2 controls the robot 1 in accordance with the target trajectory generated by the trajectory generator 37 to cause the robot 1 to treat an object.

In this configuration, the preliminary detector 34 detects the surface of the polygon from the two-dimensional image 44 using the object detection model 42, and the specifier 35 specifies the three-dimensional position information of the detected surface based on the three-dimensional information 45. In this manner, the three-dimensional position information of the surface of the object is specified based on the two-dimensional image 44 and the three-dimensional information 45. At this time, the object detection model 42 detects not a surface of a polygon of any type but a surface of a polygon of a limited type. Thus, an annotation load in leaning of the object detection model 42 is reduced. As a result, the object detection model 42 can be learned efficiently, and detection accuracy can be enhanced. In this manner, the surface of the target object W is accurately detected so that a process on an object by the robot 1 can be thereby accurately performed.

(Aspect 8) An object detection method includes: detecting a surface of a polygon of a limited type from a two-dimensional image 44 including an object, using a learned model learned by machine learning, that is, an object detection model 42; and specifying position information concerning a three-dimensional position of the detected surface, based on three-dimensional information 45 corresponding to the two-dimensional image 44.

In this configuration, the surface of the polygon is detected from the two-dimensional image 44 using the object detection model 42, and three-dimensional position information of the detected surface is specified based on the three-dimensional information 45. In this manner, the three-dimensional position information of the surface of the object is specified based on the two-dimensional image 44 and the three-dimensional information 45. At this time, the object detection model 42 detects not a surface of a polygon of any type but a surface of a polygon of a limited type. Thus, an annotation load in leaning of the object detection model 42 is reduced. As a result, the object detection model 42 can be learned efficiently, and detection accuracy can be enhanced.

1. An object detection device comprising:
a preliminary detector that detects a surface of a polygon of a limited type from a two-dimensional image including an object, using a learned model by machine learning; and
a specifier that specifies position information concerning a three-dimensional position of the surface detected by the preliminary detector, based on three-dimensional information corresponding to the two-dimensional image.

2. The object detection device according to claim 1, further comprising:
a storage that stores registration information concerning an outer shape of a surface of a target object; and
a selector that selects the surface of the target object from surfaces of which the position information is specified by comparing the position information specified by the specifier with the registration information stored in the storage.

3. The object detection device according to claim 2, wherein the registration information is information concerning at least one of a size of an interior angle, a length of a side, or an area, of the surface of the target object.

4. The object detection device according to claim 2, wherein
the specifier approximates the surface detected by the preliminary detector to a three-dimensional plane based on the three-dimensional information, and
the selector selects the surface of the target object from the surfaces of which the position information is specified, based on a variation of the three-dimensional information with respect to the plane.

5. The object detection device according to claim 2, wherein
the selector selects the surface of the target object from the surfaces of which the position information is specified, based on a missing amount of the three-dimensional information in a region corresponding to the surface detected by the preliminary detector.

6. The object detection device according to claim 2, wherein
the selector selects the surface of the target object from the surfaces of which the position information is specified, based on normal directions of the surfaces specified from the position information.

7. A robot system comprising:
a robot;
an object detector that detects an object; and
a robot controller that controls the robot, wherein
the object detector includes
a preliminary detector that detects a surface of a polygon of a limited type from a two-dimensional image including an object, using a learned model by machine learning,
a specifier that specifies position information concerning a three-dimensional position of the surface detected by the preliminary detector, based on three-dimensional information corresponding to the two-dimensional image, and
a trajectory generator that generates a target trajectory of the robot based on the position information specified by the specifier,
the robot controller controls the robot in accordance with the target trajectory generated by the trajectory generator to cause the robot to treat an object.

8. An object detection method comprising:
detecting a surface of a polygon of a limited type from a two-dimensional image including an object, using a learned model learned by machine learning; and
specifying position information concerning a three-dimensional position of the detected surface, based on three-dimensional information corresponding to the two-dimensional image.
